(19) United States
(12) Patent Application Publication
(10) Pub. No.: US 2026/0030794 A1
(43) Pub. Date: Jan. 29, 2026

(54) IMAGE GENERATION METHOD AND APPARATUS, COMPUTER DEVICE, AND STORAGE MEDIUM

(71) Applicant: Beijing Zitiao Network Technology Co., Ltd., Beijing (CN)

(72) Inventors: Yiming Fan, Beijing (CN); Qianbin He, Beijing (CN); Qianqian Wang, Beijing (CN); Yixing Huang, Beijing (CN)

(21) Appl. No.: 19/279,227

(22) Filed: Jul. 24, 2025

(30) Foreign Application Priority Data
Jul. 25, 2024 (CN) 202411009635.8

(51) Int. Cl. G06T 11/00; G06F 3/04817; G06F 3/04842; G06V 10/40

(52) U.S. Cl. CPC G06T 11/00; G06F 3/04817; G06F 3/04842; G06V 10/40

(57) ABSTRACT

The present disclosure provides an image generation method and apparatus, a computer device, and a storage medium. The method includes: displaying at least two first options on an operation interface, and determining a first selected option based on a first operation on the at least two first options; determining a target layer corresponding to the first selected option, displaying at least two second options corresponding to the target layer on the operation interface, determining a second selected option based on a second operation on the at least two second options, and adjusting a display state of the second selected option on the operation interface; displaying a first adjustment region for the second selected option on the operation interface, and generating save information based on a fourth operation on the first adjustment region; and performing image generation based on the save information in response to an image generation operation.

### CROSS-REFERENCE TO RELATED APPLICATION(S)

This application claims priority to Chinese Application No. 202411009635.8 filed Jul. 25, 2024, the disclosure of which is incorporated herein by reference in its entirety.

### FIELD

The present disclosure relates to the field of computer technologies, and in particular, to an image generation method and apparatus, a computer device, and a storage medium.

### BACKGROUND

Image generation refers to generating new images by using computer algorithms and models. These images may be completely fictional, artistically created, or obtained by modifying and enhancing existing images. With the widespread adoption and development of computer technologies, users' requirements for image generation have become increasingly specific and diversified.

### SUMMARY

The present disclosure provides an image generation method and apparatus, a computer device, and a storage medium.

According to a first aspect of the present disclosure, there is provided an image generation method. The method includes:
displaying at least two first options on an operation interface in response to an image editing operation, and determining a first selected option based on a first operation on the at least two first options;
determining a target layer corresponding to the first selected option, displaying at least two second options corresponding to the target layer on the operation interface, determining a second selected option based on a second operation on the at least two second options, and adjusting a display state of the second selected option on the operation interface;
displaying a first adjustment region for the second selected option on the operation interface in response to a third operation on the second selected option, and generating save information based on a fourth operation on the first adjustment region; and
performing image generation based on the save information in response to an image generation operation.

According to a second aspect of the present disclosure, there is provided an image generation apparatus. The apparatus includes:
a first module configured to display at least two first options on an operation interface in response to an image editing operation, and determine a first selected option based on a first operation on the at least two first options;
a second module configured to determine a target layer corresponding to the first selected option, display at least two second options corresponding to the target layer on the operation interface, determine a second selected option based on a second operation on the at least two second options, and adjust a display state of the second selected option on the operation interface;
a third module configured to display a first adjustment region for the second selected option on the operation interface in response to a third operation on the second selected option, and generate save information based on a fourth operation on the first adjustment region; and
a fourth module configured to perform image generation based on the save information in response to an image generation operation.

According to a third aspect of the present disclosure, there is provided a computer device. The computer device includes a memory, a processor, and a computer program stored on the memory and executable on the processor, where the processor, when executing the program, implements the method according to the first aspect.

According to a fourth aspect of the present disclosure, there is provided a non-transitory computer-readable storage medium storing computer instructions, where the computer instructions are configured to cause a computer to perform the method according to the first aspect.

### BRIEF DESCRIPTION OF THE DRAWINGS

In order to more clearly describe the technical solutions in embodiments of the present disclosure or in the related art, the accompanying drawings for describing the embodiments or the related art will be briefly described below. Apparently, the accompanying drawings in the description below show merely the embodiments of the present disclosure, and those of ordinary skill in the art may still derive other accompanying drawings from these accompanying drawings without creative efforts.

FIG. 1 is a schematic diagram of an exemplary system according to an embodiment of the present disclosure;

FIG. 2 is a schematic diagram of an exemplary operation interface according to an embodiment of the present disclosure;

FIG. 3A is a schematic diagram of an exemplary functional region according to an embodiment of the present disclosure;

FIG. 3B is a schematic diagram of another exemplary functional region according to an embodiment of the present disclosure;

FIG. 3C is a schematic diagram of another exemplary functional region according to an embodiment of the present disclosure;

FIG. 3D is a schematic diagram of another exemplary functional region according to an embodiment of the present disclosure;

FIG. 3E is a schematic diagram of another exemplary functional region according to an embodiment of the present disclosure;

FIG. 3F is a schematic diagram of another exemplary functional region according to an embodiment of the present disclosure;

FIG. 3G is a schematic diagram of another exemplary functional region according to an embodiment of the present disclosure;

FIG. 3H is a schematic diagram of another exemplary functional region according to an embodiment of the present disclosure;

FIG. 3I is a schematic diagram of another exemplary functional region according to an embodiment of the present disclosure;

FIG. 3J is a schematic diagram of another exemplary functional region according to an embodiment of the present disclosure;

FIG. 3K is a schematic diagram of another exemplary functional region according to an embodiment of the present disclosure;

FIG. 4 is a schematic diagram of implementation of an exemplary neural network model according to an embodiment of the present disclosure;

FIG. 5 is a schematic flowchart of an exemplary method according to an embodiment of the present disclosure;

FIG. 6 is a schematic diagram of an exemplary apparatus according to an embodiment of the present disclosure; and

FIG. 7 is a schematic diagram of an exemplary computer device according to an embodiment of the present disclosure.

### DETAILED DESCRIPTION OF EMBODIMENTS

In order to make the objectives, technical solutions, and advantages of the specification clearer, the specification is further described below in detail with reference to specific embodiments and the accompanying drawings.

It should be noted that unless otherwise defined, the technical or scientific terms used in the embodiments of the present disclosure shall have general meanings as understood by those of ordinary skill in the art to which the present disclosure pertains. “First”, “second”, and like words used in examples of the present disclosure do not indicate any order, quantity, or importance, but are merely used to distinguish between different components. “Include”, “comprise”, or like words mean that an element or item preceding the term encompasses an element or item or its equivalent listed after the term, without excluding other elements or items. “Connection”, “mutual connection”, or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

In order to make the objectives, technical solutions, and advantages of the specification clearer, the specification is further described below in detail with reference to specific embodiments and the accompanying drawings.

The current image generation function offers overly limited generation options, allowing only single selections to be made from a limited number of options, which restricts the diversification capability in image generation and imposes excessive limitations on users' choices, thus seriously affecting the user experience.

It can be seen from the above that according to the image generation method and apparatus, the computer device, and the storage medium provided in the present disclosure, more interaction options are provided for a user on the operation interface for images, and a mode for interaction with the user is adjusted, so that more diversified functional capabilities can be better provided for the user for image creation, restrictions of programs on user's creation are eliminated, and the user experience is significantly improved.

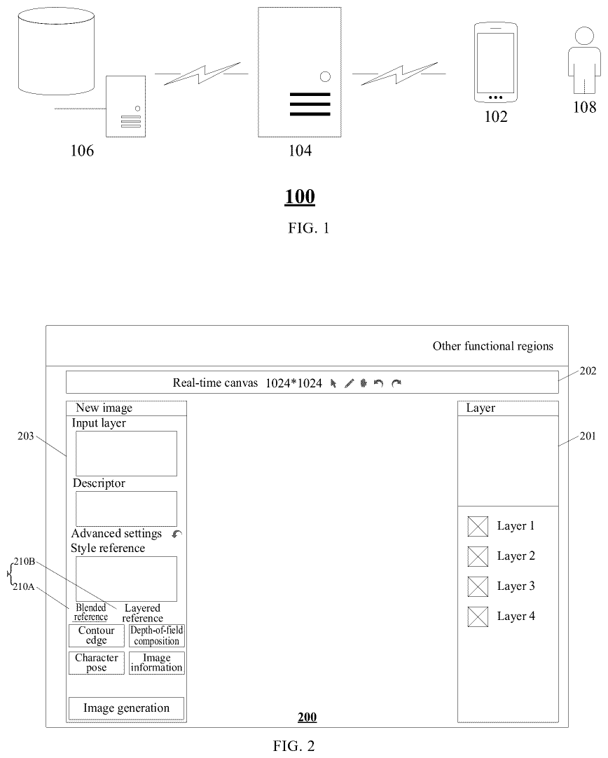

FIG. 1 is a schematic diagram of an exemplary system 100 according to an embodiment of the present disclosure. The system 100 may be a system for implementing image generation.

As shown in FIG. 1, taking a terminal device and a server jointly performing an object display method as an example, the system 100 may include a terminal device 102, a server 104, and a database server 106. The terminal device 102 and the server 104 are connected through a network, for example, connected through a wired or wireless network. Optionally, an apparatus for implementing image generation may be integrated in the terminal device 102. The database server 106 and the server 104 are connected through a network, for example, connected through a wired or wireless network. Various data related to execution of the image generation method may be stored in the database server 106, such as a base image, an image parameter, and a generation algorithm.

Various applications (APPs) may be installed on the terminal device 102, such as an image processing application, a videoconferencing application, a lifestyle service application, a book reading application, a video application, a social application, a payment application, a web browser, and an instant messaging tool. These applications can all be used for image generation and/or display of generated images. As an optional example, the application (APP) installed on the terminal device 102 may be downloaded and installed from the server 104.

The terminal device 102 here may be hardware or software. When being hardware, the terminal device 102 may be a variety of electronic devices having display screens, including but not limited to a smartphone, a tablet computer, an e-book reader, an MP3 player, a laptop computer, a desktop computer (PC), etc. When being software, the terminal device 102 may be installed on the electronic devices listed above. The terminal device may be implemented as a plurality of pieces of software or software modules (for example, for providing distributed services), or may be implemented as a single piece of software or software module. This is not specifically limited herein.

The server 104 may be a server that provides various services, for example, a background server that provides support for various applications displayed on the terminal device 102. The database server 106 may also be a database server that provides various services. It can be understood that the database server 106 may not be provided in the system 100 when the server 104 can implement relevant functions of the database server 106.

Here, the server 104 and the database server 106 may also be hardware or software. When being hardware, they may be implemented as a distributed server cluster including a plurality of servers, or may be implemented as a single server. When being software, they may be implemented as a plurality of pieces of software or software modules (for example, for providing distributed services), or may be implemented as a single piece of software or software module. This is not specifically limited herein.

It should be noted that the image generation method provided in the embodiments of the present disclosure may be performed by the system 100. Specifically, the image generation method may be performed interactively among the terminal device 102, the server 104, and the database server 106. It can be understood that the image generation method may alternatively be performed by the terminal device 102 alone when the terminal device 102 has functions of the server 104 and the database server 106 that are required for performing the image generation method. It should be understood that the numbers of terminal devices 102, servers 104, database servers 106, and users 108 in FIG. 1 are merely illustrative. According to actual needs, there may be any number of terminal devices, users, servers, and database servers.

In an exemplary application scenario, the user 108 may input an image production instruction via the terminal device 102, and the server 104 may provide an image generation service for the user 108 based on the instruction, and display an operation interface of the image generation service on a page via the terminal device 102.

As described in Background Art, in some examples, the user may perform image generation by using artificial intelligence (AI), such as generative artificial intelligence (artificial intelligence generated content (AIGC)). Image generation refers to generating new images by using computer algorithms and models. These images may be completely fictional, artistically created, or obtained by modifying and enhancing existing images.

In various image generation tools formed with the aid of AIGC, an operation interface is typically used to display images and corresponding operation functions to the operator. Using these operation functions, the operator can provide more specific references and emphases for AIGC, such as providing reference images, reference text, emphasis settings when referencing images, reference degree settings, etc., for the tools.

In some examples, the image generation tool may be software or a program with an image generation function. However, this is not specifically limited herein. Specifically, any tool that has a corresponding image generation capability and implements intelligent image generation through interaction with the operator can be considered as an image generation tool.

In a more specific scenario, the user 108 can perform image generation by using an image processing application (APP) with the aid of AIGC. It can be understood that in such a scenario, as user requirements gradually increase, relatively simple operation function selection of some applications has significantly limited user requirements for image generation capabilities. In some applications, when selecting reference emphases, only relatively simple selection can be made. For example, emphasis selection can be performed only based on a blended layer obtained by blending all layers, or only one emphasis can be selected for simple settings during function selection. These restrictions have increasingly limited a diversification capability in image generation and seriously affected the user experience.

FIG. 2 is a schematic diagram of an exemplary page 200 according to an embodiment of the present disclosure.

As shown in FIG. 2, the operation interface 200 may be a page of an image processing application, a mini program, or a web page, etc., for image production. The user 108 may open the image processing application or the mini program on the terminal device 102, or enter a corresponding website through a website program, and perform an image editing operation (e.g., click a corresponding image editing icon or input voice related to image editing) in the image processing application, the applet, or the website, such that the operation interface 200 may be displayed on the terminal device 102. It can be understood that there are many ways to enter the operation interface 200, and possible ways to enter the operation interface are described herein merely for clearer illustration.

As shown in FIG. 2, after the operation interface 200 is entered, the operation interface 200 may display a variety of elements. For example, a main central region may be used for display of a currently processed image or layer (the layer is used subsequently as an example for description). The layer displayed in this region may be a preview layer that is preliminarily generated based on a text, voice, etc., input by the user, a preview of a layer that is actively input by the user, or a layer formed by performing image generation based on a prior operation of the user. A plurality of functional regions 201 to 203, etc., may be arranged around the main central region for different functions. In a more specific scenario, the functional region 201 may be used for summarization and thumbnail display of layers, and for providing related setting functions for the layers, etc. The functional region 202 may be used for placing shortcut functions that facilitate layer editing, and for displaying relevant information of a current layer, etc. The functional region 203 may be used for the user to input and select a reference and an emphasis for image generation, for example, may provide a base reference image for image generation, set a related descriptor for reference for image generation, set a reference degree, and set an emphasis for layer reference. Further, the functions in the functional region 203 may be classified based on frequencies of use, degrees of importance, expertise intensities of the functions, etc. For example, some basic functions or functions requiring data (e.g., an input layer and a descriptor input box shown in FIG. 2) are displayed directly in the functional region, while some specialized functions (e.g., style reference and input, blended reference, and layered reference shown in FIG. 2) may be classified into advanced settings. Each setting on the operation interface 200 may be hidden initially. For example, for the advanced settings, only an identifier or icon of the advanced settings may be displayed, and specific content or functions in the advanced settings may be displayed to the user after the user clicks the identifier or icon. When the user clicks the identifier or icon again, or clicks a corresponding collapse identifier, the corresponding content or functions may be hidden or collapsed again. In some examples, for each functional region, if there is excessive content in the functional region, some content may be hidden by using a corresponding hiding solution, and the hidden content is displayed after some operations performed by the user based on the region. For example, when there is much content in the functional region 201 or the functional region 203, the content at the bottom (e.g., content beyond a range of the operation interface 200) may be hidden first; and when the user performs a slide or drag operation on the corresponding functional region, the hidden content may be gradually displayed in a moving direction, and some content in an opposite direction to the moving direction may be hidden.

In some examples, as shown in FIG. 2, for the functional region 203, due to functional limitations or design negligence of the image generation tool, when setting the emphasis for layer reference, the user may be provided with only emphasis selection for a blended layer, can select only one option during the emphasis selection, and cannot set an emphasis degree. As a result, as described above, when selecting reference emphases, only relatively simple selection can be made. Such a restriction has increasingly limited a diversification capability in image generation and seriously affected the user experience.

As shown in FIG. 2, in some examples, in order to provide the user with more interactive selections, to provide the user with more diversified functional capabilities, at least two first options 210 may first be provided on the operation interface 200 of the image generation tool. Here, the first options correspond to layers, where at least one first option (i.e., a first sub-option 210A) corresponds to the blended layer obtained by blending all layers, and at least one first option (i.e., a second sub-option 210B) corresponds to a base layer input by the user. The at least two first options 210 may be provided at any desired positions on the operation interface 200, depending on a specific usage scenario. In this example and the following examples, an example in which the at least two first options 210 are provided in the functional region 203 is used for description. This is not specifically limited.

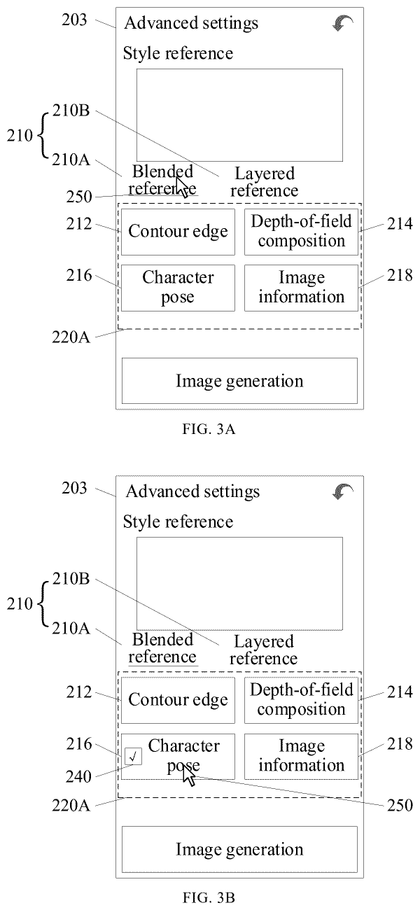

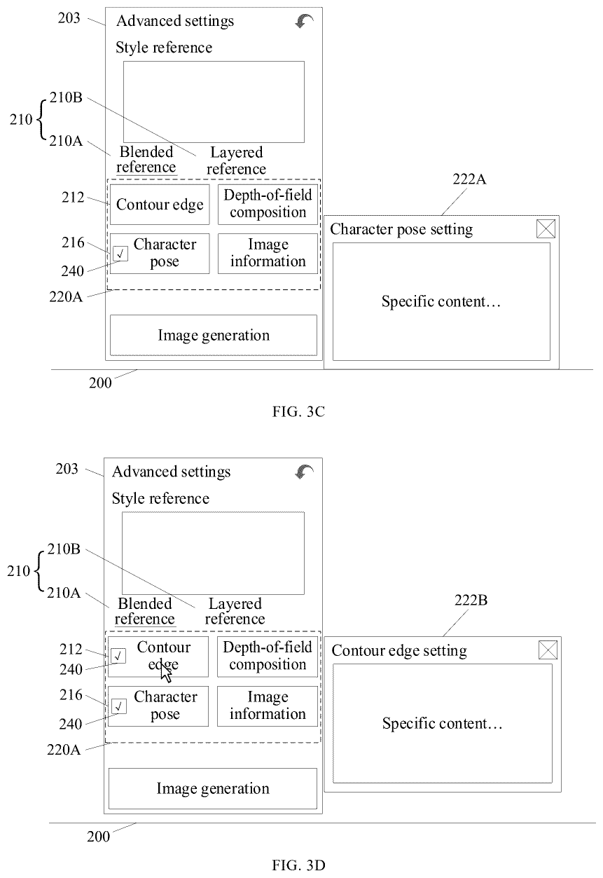

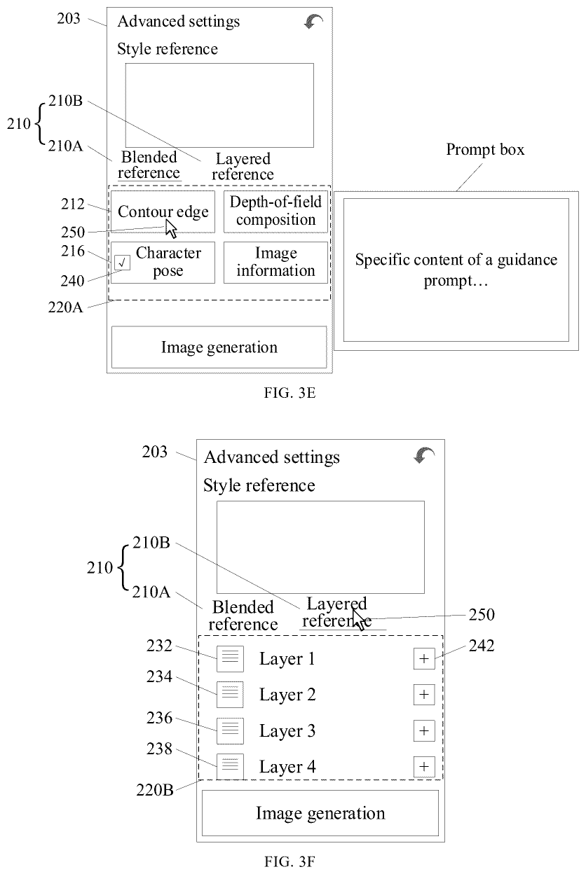

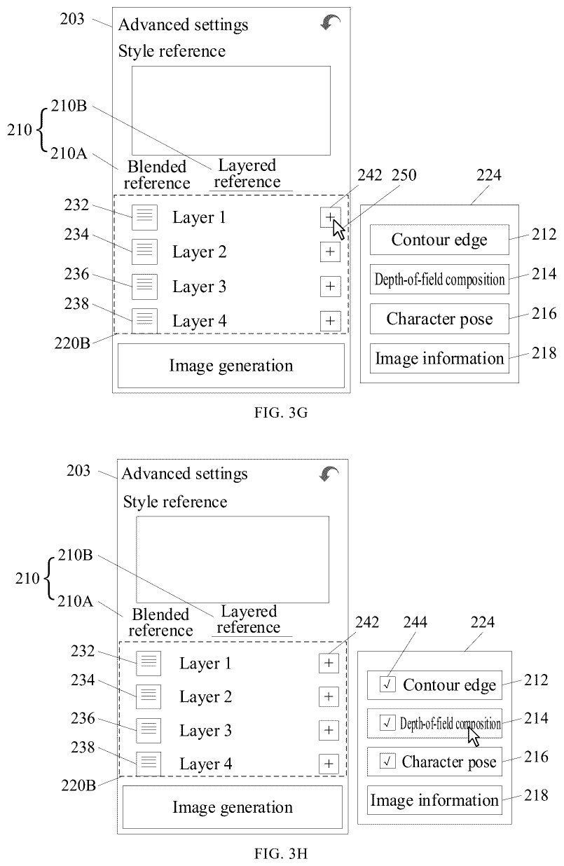

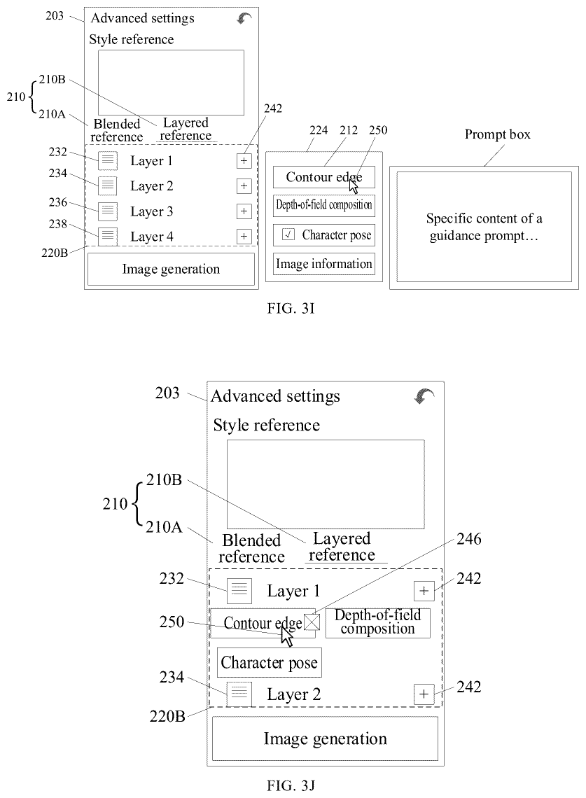

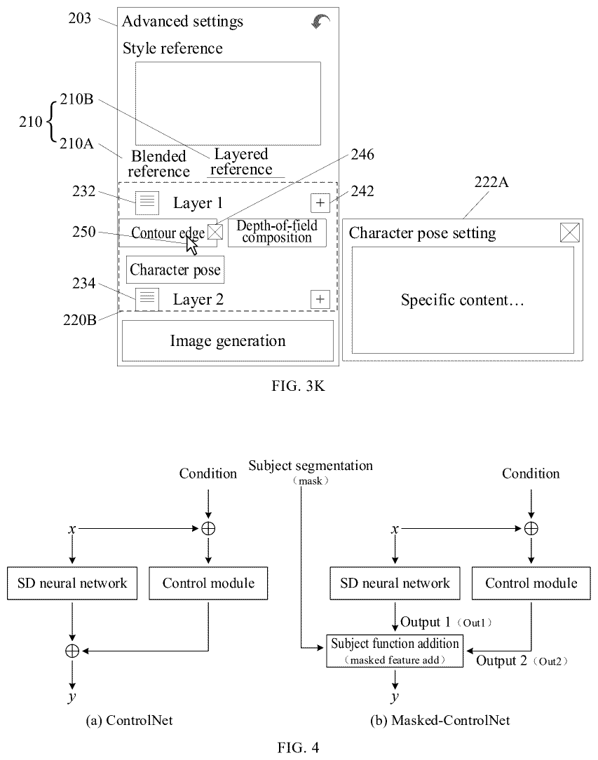

Further, only a partial region of the functional region 203 and related regions are described and displayed now. FIG. 3A to FIG. 3K are schematic partial diagrams of an exemplary operation interface 200 according to an embodiment of the present disclosure.

As shown in FIG. 3A, the at least two first options 210 are displayed on the operation interface 200, e.g., the first sub-option 210A and the second sub-option 210B. In some examples, when the user enters the operation interface 200, or expands a functional region (such as the functional region 203) corresponding to the at least two first options 210, or expands a setting in which the at least two first options 210 are located (such as the aforementioned advanced settings), specific content of one first option 210 may be displayed by default. Certainly, the specific content may alternatively be displayed only after the user performs a first operation on one of the at least two first options 210 and the option targeted by the first operation is determined as a first selected option. It can be understood that the at least two first options 210 may be displayed within a specified region of the operation interface 200. If the number of the at least two first options 210 is excessively large, a few of the first options 210 may be displayed according to a corresponding arrangement, and the others are represented through hiding or omission. When the user performs drag, slide, and other operations on the region, the hidden first options 210 may be displayed, and the previously displayed first options 210 may be hidden one by one in sequence. For example, the displayed first option 210 are dragged or slid left and right or up and down. After that, the first operation here may be a selection operation.

It should be noted that the operation shown in this example and the following examples may be a selection operation, a hover operation, a slide operation, a drag operation, etc. The selection operation may be an operation on an object with a clear trigger signal, such as a click, a double-click, and a touch. The hover operation may be an operation of making an operating control (e.g., a mouse pointer), a touch point, etc., hover over a place, such as staying on the object (for a time exceeding a certain threshold), and a touch (with a pressing force less than a certain threshold). The slide operation may be an operation formed by sliding of the operation control or the touch point. The drag operation may be an operation formed by applying a clear trigger signal to an object followed by a slide operation. The operations are only provided herein as examples for description. This is not specifically limited. In this example and the following examples, an example in which the user performs a corresponding operation via a mouse pointer 250 is used for description.

After the user selects the first selected option via the mouse pointer 250, it is necessary to determine a target layer that the user wants to operate, that is, to determine the target layer corresponding to the first selected option. When the first sub-option 210A is the first selected option, the blended layer is the target layer. When the second sub-option 210B is the first selected option, further determination is required since there may be a plurality of base layers provided by the user.

In some examples, an example in which the first sub-option 210A is the first selected option is first used for description. As shown in FIG. 3A, when the user selects the first sub-option 210A by performing the selection operation via the mouse pointer 250, it may be directly determined that the target layer is the blended layer, and then at least two second options 212 to 218 corresponding to the target layer may be displayed on the operation interface 200. The at least two second options 212 to 218 may be displayed in a first region 220A corresponding to the first sub-option 210A, or may be provided at any position on the operation interface 200 in the same or similar manner as the first option 210 described above. This is not specifically limited, and details are not described herein again. In a more specific scenario, the at least two second options may be a plurality of options for reference with different emphases, such as a contour edge option, a depth-of-field composition option, a character pose option, an image information option, and a subject option. In addition, if there are excessive second options, the second options may be hidden and displayed in the same or similar manner as the first option 210 in the above examples. Details are not described herein again.

Further, in some examples, the first region 220A corresponding to the first sub-option 210A is expanded on the operation interface 200, and the at least two second options 212 to 218 corresponding to the first sub-option 210A are displayed in the first region 220A. Then, a first contour of each or any one of the at least two second options 212 to 218 may be determined, and a first response region may be set based on the first contour. Corresponding contour options may be set for the second options 212 to 218, such as a rectangular contour, a circular contour, an elliptical contour, or a contour of a user-defined pattern. A corresponding response region may be set based on the first contour, and an operation on the response region may be considered as an operation on the corresponding second option. For example, if a selection operation is performed in a response region for the second option 212, it may be determined that an object of the selection operation is the second option 212. It should be noted that the response region may be set to the same size as the corresponding contour, set to be slightly larger or smaller than the corresponding contour, or set according to the user's definition. That is, ranges of the response region and the corresponding contour are not exactly the same.

After the at least two second options 212 to 218 are displayed, a second selected option needs to be determined from the second options 212 to 218. As shown in FIG. 3B, through a selection operation on a second option, the selected second option may be determined as the second selected option. For example, the second option 216 is clicked with the mouse pointer 250. Specifically, based on a selection operation on a first response region corresponding to the second option 216, the second option 216 corresponding to the operated first response region may be determined as the second selected option, and a first identifier 240 may be displayed in a first contour of the second option 216, to indicate, by adjusting a display state of the second option 216, that the second option 216 is selected as the second selected option.

In a specific scenario, the first identifier 240 may be any symbol indicating being selected, such as a “√” provided in a box shown in FIG. 3B. This is not specifically limited.

For the second selected option, the user may also deselect the second selected option through a corresponding operation. In addition, in order to prevent a misoperation of the user, a response region for the deselection operation may be set smaller or clearer. For example, the corresponding second selected option may be deselected only after the user performs a selection operation on the first identifier 240.

In some examples, after the user selects a second selected option, a first adjustment region 222A corresponding to the second selected option may be further expanded on the operation interface 200 when the user performs a third operation on the second selected option, as shown in FIG. 3C. The first adjustment region 222A may be displayed on the operation interface 200 in the form of a new window, or may be a newly delimited region in a current interface. The third operation here may be a selection operation or a hover operation. For example, after the selection operation is performed for the first time to select the second option 216 as the second selected option, the selection operation is performed again on the second option 216, to generate the first adjustment region 222A. Alternatively, after the selection operation is performed for the first time to select the second option 216 as the second selected option, the hover operation is performed in the response region for the second option 216, to generate the first adjustment region 222A.

In addition, in some examples, in order to make it convenient for the user to adjust the second selected option, when the selection operation is performed for the first time to select a second option as the second selected option, a corresponding adjustment region may be formed synchronously. For example, as shown in FIG. 3D, when the user performs the selection operation on the second option 212 for the first time, an adjustment region is generated synchronously, i.e., a second adjustment region 222B. This setting allows specific adjustments performed directly through the second adjustment region 222B after the user has set a second selected option. Then, when the user wants to perform adjustment again, the first adjustment region 222A may be generated through the above third operation, and content therein may be readjusted. In this example, content displayed in the first adjustment region 222A and the second adjustment region 222B is essentially the same, with the only difference being trigger conditions.

It should be noted that, as shown in FIG. 3C or FIG. 3D, the first adjustment region 222A and the second adjustment region 222B may be used for displaying a specific reference degree of the corresponding second selected option, where the specific reference degree of the selected option may be determined by providing an input box, a drag bar, etc. In another example, the content in the first adjustment region 222A and the second adjustment region 222B may be set with specific content (e.g., a plurality of related parameters, and range adjustment) of the corresponding second selected option. This is not specifically limited.

Further, as shown in FIG. 3C or FIG. 3D, although the displayed first adjustment region 222A or second adjustment region 222B may be provided at any position on the operation interface 200 in some examples, in order to improve the user experience and strengthen an association between the first adjustment region 222A or the second adjustment region 222B and the corresponding second selected option, the position of the first adjustment region 222A or the second adjustment region 222B may be defined in some other examples. As shown in FIG. 3D, an edge of the first adjustment region 222A or the second adjustment region 222B may be aligned with at least one edge of the first contour of the corresponding second selected option. In FIG. 3D, an upper edge of the second adjustment region 222B is aligned with an upper edge of the second option 212. As shown in FIG. 3C, if the generated first adjustment region 222A or second adjustment region 222B is aligned with one edge of the first contour of the corresponding second selected option, a range of the first adjustment region 222A or the second adjustment region 222B may exceed the range of the operation interface 200. In this case, the edge of the first adjustment region 222A or the second adjustment region 222B may be aligned with one edge of the operation interface 200. In FIG. 3C, a lower edge of the first adjustment region 222A is aligned with a lower edge of the operation interface 200.

After the user completes the setting adjustment for the corresponding second selected option in the first adjustment region 222A or the second adjustment region 222B, that is, the user correspondingly sets the content in the first adjustment region through a fourth operation, the set content may be saved, to generate corresponding save information. The fourth operation here may be a selection operation on some content, a drag or slide operation on some content, an input operation on some content, etc., in the first adjustment region 222A or the second adjustment region 222B. In some examples, after completing setting, the user may further perform a confirmation operation, such as clicking a confirmation button. Alternatively, after completing setting, the user may directly perform an operation to close the adjustment region, such that set information is confirmed by default and needs to be saved. Alternatively, the mouse pointer 250 may be moved out of a region in which the first adjustment region 222A or the second adjustment region 222B is located, and another operation (e.g., a click in another region) may be performed, to determine that the user has completed setting the content in the first adjustment region 222A or the second adjustment region 222B, such that save information may be generated based on the information set by the user. In some more specific scenarios, a reference degree of the contour edge option, the depth-of-field composition option, the character pose option, or the picture information option may be displayed in the first adjustment region 222A or the second adjustment region 222B.

Further, for closing or canceling the first adjustment region 222A or the second adjustment region 222B, a corresponding close or cancel identifier may be provided in the first adjustment region 222A or the second adjustment region 222B, and the user closes or cancels the first adjustment region 222A or the second adjustment region 222B by triggering the identifier. In addition, in some other examples, the first adjustment region 222A or the second adjustment region 222B may be closed or canceled through another operation of the user in a region outside the first adjustment region 222A or the second adjustment region 222B. For example, a selection operation, etc., may be performed in another blank region or another functional region on the operation interface 200 outside the first adjustment region 222A or the second adjustment region 222B, or a selection operation, etc., may be directly performed again on the first response region for the second selected option corresponding to the first adjustment region 222A or the second adjustment region 222B. That is, in some examples, display of the first adjustment region 222A or the second adjustment region 222B is canceled in response to a selection operation on a region outside the first adjustment region 222A or the second adjustment region 222B.

Finally, when the user performs an image generation operation on the operation interface 200, for example, as shown in FIG. 3A, when the user clicks an image generation button via the mouse pointer 250, it may be considered that the user performs the image generation operation. The terminal device 102 or the server 104 may generate an image with reference to the save information. After that, in a more specific scenario, if a plurality of controllable capabilities are used for one image generation result (i.e., the user selects a plurality of second options), a plurality of images may be displayed when image generation is performed. Different images have different emphases, and the display logic may be displaying in an order of “style reference and blended reference/layered reference”. In addition, in a specific application, if there are excessive images generated or labels, the images or labels may be displayed through omission or hiding, and omitted or hidden images or labels may be displayed after the user completes a specific operation (such as a slide or drag operation in a specific region).

In some other examples, since a plurality of second selected options may be determined, as shown in FIG. 3D, after the second option 216 is determined as a second selected option, the second option 212 is determined as another second selected option. In this case, setting excessive references may also affect the image generation effect. For example, if all the second options are selected, for the terminal device 102 or the server 104, assuming that a reference emphasis of each second option is increased by 50, but a relative value between the second options is not changed substantially, it is essentially equivalent to selecting none of the second options. Here, a selection upper limit is set for the user. For example, in the above example in which the contour edge option, the depth-of-field composition option, the character pose option, or the picture information option is set, a set threshold used as the upper limit may be set to 3. When the user has selected three second selected options, the user may be prevented from selecting a fourth second selected option through an operation, and a corresponding prompt may be generated. In some other examples, when the user has selected a fourth second selected option through an operation, the second selected option that is selected the earliest in time is deselected, to ensure that there are only three second selected options, and in addition, the user may be prompted with a text or voice (first prompt information is generated). That is, in some examples, when the display state of the second selected option is adjusted on the operation interface 200, the second selected option that is determined the earliest in time is deselected in response to the number of second selected options present on the operation interface 200 exceeding the set threshold. In some examples, the first prompt information is generated after the second selected option that is determined the earliest in time is deselected.

For the second options 212 to 218, when the mouse pointer 250 is moved to a response region for one second option, in order to enable the user to clearly perceive the action and understand that if an operation is performed now, an object of the operation is the corresponding second option, in some examples, when the user performs a seventh operation on any first response region, the first contour corresponding to the operated first response region may be displayed differently. Whether or not the second option corresponding to the first response region or the first contour is selected as the second selected option, the first contour may be displayed differently through the seventh operation. The seventh operation here may be a move operation or a slide operation, i.e., moving or sliding the mouse pointer 250 into the first response region corresponding to the second option, such that the first contour of the second option may be displayed differently. The different display here may be highlighting, or different display in the form of another color, a demonstration animation, an image, etc., that is, display different from the other second options. A specific form of the different display is not specifically limited herein.

In some other examples, as shown in FIG. 3E, before the user selects one of the second options 212 to 218 as the second selected option, since the user may not know much about a function of the corresponding second option, some prompt guidance may be given to the user for reference. For example, when the user selects the second selected option, if the mouse pointer 250 hovers over a second option, which is a hover operation of the mouse pointer 250 over the first response region corresponding to the second option 212 in FIG. 3E, a guidance prompt in the form of text, voice, images, or video may be generated. The content of the guidance prompt corresponds to a second option (i.e., the second option 212) corresponding to the operated first response region, and the guidance prompt in the form of text, images, or video may be implemented through display within a prompt box. After that, once a second option is determined as the second selected option, it indicates that the user has clearly identified the corresponding function. At this point, if a hover operation, etc., is performed again, no guidance prompt will be generated. Instead, a further setting region such as the first adjustment region 222A can be generated. This prevents the user from being bothered by excessive guidance prompts and enhances the user experience.

In some other examples, an example in which the second sub-option 210B is the first selected option is then used for further description, where the second sub-option corresponds to a base layer. This may be understood as layered reference. As shown in FIG. 3F, the user selects the second sub-option 210B by performing a selection operation via the mouse pointer 250, and further determination of the target layer is required since there may be more than one base layer provided by the user. Specifically, as shown in FIG. 3F, at least one icon 232 to 238 corresponding to at least one base layer may be displayed on the operation interface 200, to facilitate selection of the target layer. The at least one icon 232 to 238 may be displayed in a second region 220B corresponding to the second sub-option 210B, or may be provided at any position on the operation interface 200 in the same or similar manner as the first option 210 or the second options 212 to 218 described above. This is not specifically limited, and details are not described herein again. In addition, if there are excessive icons or a space of the second region 220B is limited, the icons may be hidden and displayed in the same or similar manner as the first option 210 or the second options 212 to 218 in the above examples. Details are not described herein again. It can be seen that the second region 220B may overlap or partially overlap with the first region 220A. When the two regions at least partially overlap, according to the selection of the first sub-option 210A or the second sub-option 210B by the user, the corresponding region is displayed, and the other region is hidden.

After that, based on a fifth operation on any one of the at least one icon 232 to 238, a base layer corresponding to the operated icon may be determined as the target layer. The fifth operation here may be a selection operation on the icon. Alternatively, the fifth operation is a selection operation on a region in which the icon is located. For example, as shown in FIG. 3F, one icon may correspond to one lateral rectangular region in the second region 210B. Alternatively, a corresponding second identifier 242 may be further displayed for each icon in the second region 210B, and after the user performs a selection operation on any second identifier 242, it may be considered that a fifth operation is performed on an icon corresponding to the selected second identifier. As an example, the second identifier 242 may correspond to any symbol, such as a “+” provided in a box shown in FIG. 3F. This is not specifically limited.

In some examples, for the second identifier 242 selected through the fifth operation, the selected second identifier 242 may be displayed differently in the same or similar form as in the above examples in which the second option is displayed differently. After the mouse pointer 250 is moved to a region in which the second identifier 242 is located, the second identifier 242 is displayed differently, such as highlighted. Details are not described herein again. This is not specifically limited.

For the second identifier 242 selected through the fifth operation, it is further desirable to display the at least two second options 212 to 218 corresponding to the target layer on the operation interface 200, in the same or similar display manner as in the above examples. Details are not described herein again. After that, as shown in FIG. 3G, in some examples, a third region 224 may be generated at one side of the selected second identifier 242, and the at least two second options 212 to 218 are displayed in the third region 224. A position where the third region 224 is provided is not specifically limited herein. In order to further improve the user experience and to emphasize an association between the third region 224 and the selected second identifier 242, the third region 224 may be displayed at one side of the selected second identifier 242.

After that, similar to the above examples, the contours and response regions of the at least two second options 212 to 218, i.e., second contours and second response regions in this example, are also determined.

In some examples, as shown in FIG. 3H, similar to the above examples, for selection of one of the at least two second options 212 to 218 as the second selected option, based on a selection operation on any second response region, a second option corresponding to the operated second response region may be determined as the second selected option, and a third identifier 244 is displayed in a second contour of the second selected option.

In a specific scenario, the third identifier 244 may be the same as or similar to the first identifier 240, such as a “V” provided in a box shown in FIG. 3H. This is not specifically limited.

Similarly, for the second selected option, the user may also deselect the second selected option through a corresponding operation. In addition, in order to prevent a misoperation of the user, a response region for the deselection operation may be set smaller or clearer. For example, the corresponding second selected option may be deselected only after the user performs a selection operation on the third identifier 244.

Further, since only selection of the second selected option corresponding to the corresponding target layer is involved here, no adjustment region may be displayed here. Instead, after the user has determined all second selected options corresponding to a target layer, corresponding adjustment regions may be displayed through other operations.

After that, for the second options 212 to 218, when the mouse pointer 250 is moved to a response region for one second option, in order to enable the user to clearly perceive the action and understand that if an operation is performed now, an object of the operation is the corresponding second option, in some examples, when the user performs an eighth operation on any second response region, a second contour corresponding to the operated second response region may be displayed differently. Whether or not the second option corresponding to the second response region or the second contour is selected as the second selected option, the second contour may be displayed differently through the eighth operation. The eighth operation here may be a move operation or a slide operation, i.e., moving or sliding the mouse pointer 250 into the second response region corresponding to the second option, such that the second contour of the second option may be displayed differently. After that, a specific form of the different display is the same as or similar to that in the above examples, and details are not described herein again.

In some other examples, as shown in FIG. 3I, before the user selects one of the second options 212 to 218 as the second selected option, since the user may not know much about a function of the corresponding second option, some prompt guidance may be given to the user for reference. For example, when the user selects the second selected option, when the mouse pointer 250 hovers over a second option, which is a hover operation of the mouse pointer 250 in the second response region corresponding to the second option 212 in FIG. 3I, a guidance prompt in the form of a text, voice, an image, or a video may be generated. After that, a specific form of the guidance prompt is the same as or similar to that in the above examples, and details are not described herein again.

Further, like or similar to the above examples, as shown in FIG. 3H, since a plurality of second selected options may be determined, a selection upper limit may also be set for the user here. That is, a corresponding set threshold is set. After the set threshold is reached, a subsequent processing process may be the same as or similar to that in the above examples. That is, in some examples, after the third identifier 244 is displayed in the second contour of the second selected option, the second selected option that is determined the earliest in time is deselected in response to the number of second selected options present in the third region 224 exceeding the set threshold. In some examples, second prompt information is generated after the second selected option that is determined the earliest in time is deselected.

In some examples, after the user selects at least one corresponding second selected option in the third region 224, a determination operation (sixth operation) is generally required to determine that the current second selected option correspond to a current target layer. The determination operation (sixth operation) may be completed by selecting a confirmation button which is provided in the third region. Alternatively, the determination operation may be completed through a selection operation in a region outside the third region 224 or a selection operation on the second identifier 242. The third region 224 may be canceled after the determination operation is performed. In addition, after a second selected option corresponding to a target layer is determined, a display state of the second selected option corresponding to the target layer may be adjusted on the operation interface 200. As shown in FIG. 3J, the second selected option may be displayed in a region corresponding to an operated icon (an icon corresponding to the target layer) in the second region 210B, to adjust the display state of the second selected option. In addition, a third contour of these second selected option is determined similarly to the first contour and the second contour described above, and a third response region for the second selected option is determined similarly to the first response region and the second response region described above.

In some examples, after the display state of the second selected option is adjusted, when the user moves the mouse pointer 250 to the third response region corresponding to the second selected option through a slide operation, the third contour of the second selected option to which the slide operation points may also be displayed differently for the same or similar reasons as in the previous similar examples. Since a deselection operation may also be performed on the second selected option, a fourth identifier 246 may be displayed in the third contour during different display. In a specific scenario, the fourth identifier 246 may be any symbol indicating deletion, such as an “x” symbol provided in a box shown in FIG. 3J, or a symbol similar to a trash can. This is not specifically limited. After that, when the user performs a selection operation on the fourth identifier 246, the corresponding second selected option may be deselected. After a second selected option is deselected, a region corresponding to an operated icon in the second region 220B may be adjusted by setting a corresponding dynamic effect or the like in the second region 220B, and even the size of the entire second region 220B may change accordingly. For example, in a scenario where two second selected options are displayed in a row, after one second selected option is deselected, there may be no second selected option in the entire row, and the entire region may then be processed with a corresponding vanishing dynamic effect. This may also happen in a scenario where there is still a second selected option after the second selected option deselected, and the second selected option may then be processed with a corresponding follow-up or fill-in dynamic effect.

After that, after the display state of the second selected option is adjusted, when the user performs a third operation on the second selected option, as shown in FIG. 3K, a first adjustment region 222A corresponding to the second selected option may be displayed on the operation interface. The first adjustment region 222A here is the same as or similar to the first adjustment region 222A described in the above examples. Details are not described herein again.

Similarly, as shown in FIG. 3K, an edge of the displayed first adjustment region 222A is aligned with at least one edge of a third contour of the corresponding second selected option. Alternatively, the first adjustment region 222A is aligned with at least one edge of the operation interface 200.

Similarly, after the user completes the setting adjustment for the corresponding second selected option in the first adjustment region 222A, that is, the user correspondingly sets content in the first adjustment region through a fourth operation, the set content may be saved, to generate corresponding save information.

Further, for closing or canceling the first adjustment region 222A, like or similar to the above similar examples, the display of the first adjustment region 222A can be canceled in response to a ninth operation on a region outside the first adjustment region 222A.

In some other examples, since the functional region 201 can display corresponding layers, it is mainly used for displaying corresponding base layers in this example. For these layers, a hiding operation can be performed, for example, setting an identifier for hiding. When the user selects the identifier, the corresponding base layer is hidden. After the user performs a hiding operation on a base layer, the corresponding base layer in the second region 220B can also be accordingly synchronously hidden, and a corresponding icon can also be synchronously hidden. In addition, for the hidden base layer, saving of the corresponding save information is not affected.

In some other examples, the number of layers in the second region 220B also needs to be limited to some extent. For example, the set threshold may be set to 5 layers. When the number of base layers input by the user exceeds this set threshold, only icons corresponding to the set threshold number of layers are displayed in the second region. At the same time, the user is prompted with third prompt information, making it convenient for the user to understand the rules and adjust the displayed layers.

In some examples, for the save information, since the first sub-option 210A corresponds to a blended layer and the second sub-option 210B corresponds to each base layer, there is an inherent conflict between the two. Therefore, when creating a piece of save information, if there exists other save information (which may come from the user's operation on other sub-options, or the user's previous operation on the current sub-option), it can be directly overwritten to ensure the validity of the latest save information.

Finally, after the corresponding save information is generated, the user can perform an image generation operation on the operation interface 200, so that image generation can be performed based on the save information. In a more specific application scenario, for the logic following the user's image generation operation on the operation interface 200, if settings for blended references (the first sub-option) or layered references (the second sub-option) are performed, image generation is performed based on specific settings such as the set references and weights. For other cases, they can generally be divided as follows. (1) If the user has not performed settings for any reference dimension (the second option) of blended references (the first sub-option 210A) or layered references (the second sub-option 210B), unified superimposition is performed by default based on the reference dimensions of the second option (e.g., four reference dimensions of “contour edge”, “depth-of-field composition”, “character pose”, and “image information”) to obtain a set number of (e.g., four) results for each reference dimension. In this case, for each result, when the user holds the mouse pointer 250 on the result, an enlarged preview of the result can be displayed, along with labels indicating the corresponding reference dimensions. (2) For the layered references (the second sub-option), if the user has only set some layers while leaving other layers unset, for all layers with reference dimensions added, image generation proceeds based on the settings. For example, the corresponding reference weights are high (the degree may also be determined based on an operation of the user). For all layers without reference dimensions added, the image generation will be based on a combination of the reference dimensions of the second option (e.g., four reference dimensions of “contour edge”, “depth-of-field composition”, “character pose”, and “image information”) with the weights of the layers with reference dimensions added to obtain a set number of (e.g., four) results for each reference dimension.

In a specific application scenario, the implementation of the solution in the above example may be achieved with the aid of a corresponding neural network tool, such as a ControlNet model. A plurality of ControlNets may be concatenated and stacked, and the functions of the second options 212 to 218 (e.g., the contour edge, the depth-of-field composition, the character pose, and the image information) can be implemented based on the ControlNets, while the subject remains implemented based on a Masked-ControlNet. As shown in FIG. 4, (a) is a schematic diagram of the implementation of the ControlNet, and (b) is a schematic diagram of the implementation of the Masked-ControlNet. Here, x is an input of the layer, and for an output layer y:

$$y = feature + {\sum }_{condition} {feature}_{condition} + {feature}_{subject} * mask$$

where condition indicates any input in the second options 212 to 218 (e.g., the contour edge, the depth-of-field composition, the character pose, and the image information) in any number and any combination; subject is the subject of the layer, and mask is the result of saliency segmentation of the image, which is 1 for the subject region, and 0 for a background region, feature is part or all of the features of the corresponding input layer x.

It can be seen that during specific image generation, original feature information (i.e., a first feature) of the target layer is first determined, i.e., the feature item. Then, control feature information (i.e., a second feature) of each dimension is determined based on the user's input, i.e., the finally formed save information. The corresponding weight, i.e., the Σ_{condition} feature_{condition} item, is set based on the control feature information in conjunction with the settings made by the user in the first adjustment region, e.g., the set reference degrees of the contour edge, the depth-of field-composition, the character pose, and the image information. After that, in order to ensure that the subject of the generated image does not deviate significantly from the subject in the target layer provided by the user, the subject of the generated image undergoes segmentation, i.e., saliency segmentation, and a part belonging to the subject is strengthened or protected, i.e., the feature_{subject}*mask item. This serves as the model's objective for image generation. That is, in some examples, the performing image generation based on the save information in response to an image generation operation includes: determining a first feature and subject information of the target layer; determining a second feature corresponding to the target layer and a corresponding weight based on the save information; and performing the image generation based on the first feature, the second feature, the weight, and the subject information.

It can be seen from the above embodiments that according to the image generation method provided in the embodiments of the present disclosure, more interaction options are provided for the user on the operation interface for images, and a mode for interaction with the user is adjusted, so that more diversified functional capabilities can be better provided for the user for image creation, restrictions of programs on user's creation are eliminated, and the user experience is significantly improved.

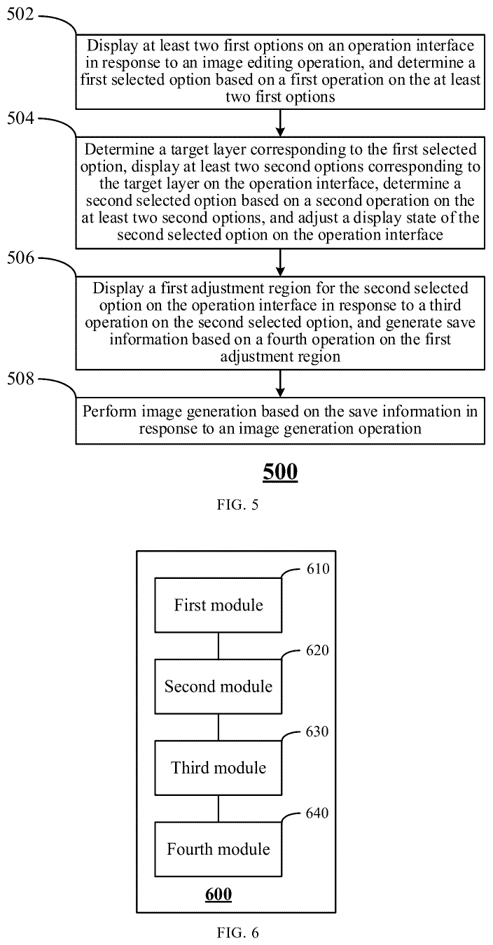

FIG. 5 is a schematic flowchart of an exemplary method 500 according to an embodiment of the present disclosure.

The method 500 is used for image generation, and may be implemented by the terminal device 102 alone or by the system 100. As shown in FIG. 5, the method 500 may include the following steps.

Step 502: Display at least two first options on an operation interface in response to an image editing operation, and determine a first selected option based on a first operation on the at least two first options.

Step 504: Determine a target layer corresponding to the first selected option, display at least two second options corresponding to the target layer on the operation interface, determine a second selected option based on a second operation on the at least two second options, and adjust a display state of the second selected option on the operation interface.

Step 506: Display a first adjustment region for the second selected option on the operation interface in response to a third operation on the second selected option, and generate save information based on a fourth operation on the first adjustment region.

Step 508: Perform image generation based on the save information in response to an image generation operation.

In some exemplary embodiments, the at least two first options include a first sub-option configured to correspond to a blended layer, where when the first sub-option is the first selected option, the blended layer is the target layer; and the displaying at least two second options corresponding to the target layer on the operation interface includes: expanding a first region corresponding to the first sub-option on the operation interface; and displaying the at least two second options corresponding to the first sub-option in the first region.

In some exemplary embodiments, the determining a second selected option based on a second operation on the at least two second options, and adjusting a display state of the second selected option on the operation interface includes: determining, based on the second operation on any one of the second options, the operated second option as the second selected option; and setting a first identifier for the second selected option, to adjust the display state of the second selected option.

In some exemplary embodiments, the adjusting a display state of the second selected option on the operation interface includes: deselecting, in response to the number of second selected options present on the operation interface exceeding a set threshold, the second selected option that is determined the earliest in time, and generating first prompt information.

In some exemplary embodiments, the at least two first options include a second sub-option configured to correspond to at least one base layer, where when the second sub-option is the first selected option, the determining a target layer corresponding to the first selected option includes: expanding a second region corresponding to the second sub-option on the operation interface; and displaying at least one icon corresponding to the at least one base layer in the second region, and determining, based on a fifth operation on any one of the at least one icon, a base layer corresponding to the operated icon as the target layer.

In some exemplary embodiments, the based on a fifth operation on any one of the at least one icon includes: displaying at least one second identifier corresponding to the at least one base layer in the second region; and determining a selection operation on any one of the at least one second identifier as the fifth operation on an icon corresponding to the selected second identifier.

In some exemplary embodiments, the displaying at least two second options corresponding to the target layer on the operation interface, determining a second selected option based on a second operation on the at least two second options includes: generating a third region at one side of the selected second identifier, and displaying the at least two second options in the third region; and determining, based on the second operation on any one of the at least two second options, the operated second option as the second selected option, and setting a third identifier for the second selected option.

In some exemplary embodiments, the adjusting a display state of the second selected option on the operation interface includes: canceling the third region in response to a sixth operation on the selected second identifier or a region outside the third region; and displaying the second selected option in a region in the second region that corresponds to the operated icon.

In some exemplary embodiments, after the displaying at least one icon corresponding to the at least one base layer in the second region, the method further includes: displaying, in response to the number of the at least one base layer exceeding a set threshold, the set threshold number of icons among the at least one icon in the second region, and generating third prompt information.

In some exemplary embodiments, the performing image generation based on the save information in response to an image generation operation includes: determining a first feature and subject information of the target layer; determining a second feature corresponding to the target layer and a corresponding weight based on the save information; and performing the image generation based on the first feature, the second feature, the weight, and the subject information.

According to the image generation method provided in this embodiment of the present disclosure, more interaction options are provided for the user on the operation interface for images, and a mode for interaction with the user is adjusted, so that more diversified functional capabilities can be better provided for the user for image creation, restrictions of programs on user's creation are eliminated, and the user experience is significantly improved.

It should be noted that the method in the embodiments of the present disclosure may be performed by a single device, such as a computer or a server. The method in the embodiments of the present disclosure may alternatively be applied to a distributed scenario and completed through cooperation of a plurality of devices. In the distributed scenario, one of the plurality of devices may perform only one or more steps of the method in the embodiments of the present disclosure. The plurality of devices interact with each other to complete the method.

It should be noted that specific embodiments of the present disclosure are described above. Other embodiments are within the scope of the appended claims. In some cases, the actions or steps recited in the claims can be performed in an order different from that in the above embodiments, and can still achieve desired results. In addition, the processes depicted in the accompanying drawings are not necessarily required to be shown in a particular or sequential order, to achieve desired results. In some implementations, multi-task processing and parallel processing are also possible or may be advantageous.

Based on the same technical concept, corresponding to the method in any one of the above embodiments, the present disclosure further provides an image generation apparatus.

Referring to FIG. 6, the image generation apparatus 600 includes:
a first module 610 configured to display at least two first options on an operation interface in response to an image editing operation, and determine a first selected option based on a first operation on the at least two first options;
a second module 620 configured to determine a target layer corresponding to the first selected option, display at least two second options corresponding to the target layer on the operation interface, determine a second selected option based on a second operation on the at least two second options, and adjust a display state of the second selected option on the operation interface;
a third module 630 configured to display a first adjustment region for the second selected option on the operation interface in response to a third operation on the second selected option, and generate save information based on a fourth operation on the first adjustment region; and
a fourth module 640 configured to perform image generation based on the save information in response to an image generation operation.

In some exemplary embodiments, the at least two first options include a first sub-option configured to correspond to a blended layer, where when the first sub-option is the first selected option, the blended layer is the target layer; and the displaying at least two second options corresponding to the target layer on the operation interface includes: expanding a first region corresponding to the first sub-option on the operation interface; and displaying the at least two second options corresponding to the first sub-option in the first region.

In some exemplary embodiments, the determining a second selected option based on a second operation on the at least two second options, and adjusting a display state of the second selected option on the operation interface includes: determining, based on the second operation on any one of the second options, the operated second option as the second selected option; and setting a first identifier for the second selected option, to adjust the display state of the second selected option.

In some exemplary embodiments, the adjusting a display state of the second selected option on the operation interface includes: deselecting, in response to the number of second selected options present on the operation interface exceeding a set threshold, the second selected option that is determined the earliest in time, and generating first prompt information.

In some exemplary embodiments, the at least two first options include a second sub-option configured to correspond to at least one base layer, where when the second sub-option is the first selected option, the determining a target layer corresponding to the first selected option includes: expanding a second region corresponding to the second sub-option on the operation interface; and displaying at least one icon corresponding to the at least one base layer in the second region, and determining, based on a fifth operation on any one of the at least one icon, a base layer corresponding to the operated icon as the target layer.

In some exemplary embodiments, the based on a fifth operation on any one of the at least one icon includes: displaying at least one second identifier corresponding to the at least one base layer in the second region; and determining a selection operation on any one of the at least one second identifier as the fifth operation on an icon corresponding to the selected second identifier.

In some exemplary embodiments, the displaying at least two second options corresponding to the target layer on the operation interface, determining a second selected option based on a second operation on the at least two second options includes: generating a third region at one side of the selected second identifier, and displaying the at least two second options in the third region; and determining, based on the second operation on any one of the at least two second options, the operated second option as the second selected option, and setting a third identifier for the second selected option.

In some exemplary embodiments, the adjusting a display state of the second selected option on the operation interface includes: canceling the third region in response to a sixth operation on the selected second identifier or a region outside the third region; and displaying the second selected option in a region in the second region that corresponds to the operated icon.

In some exemplary embodiments, after the displaying at least one icon corresponding to the at least one base layer in the second region, the method further includes: displaying, in response to the number of the at least one base layer exceeding a set threshold, the set threshold number of icons among the at least one icon in the second region, and generating third prompt information.

In some exemplary embodiments, the performing image generation based on the save information in response to an image generation operation includes: determining a first feature and subject information of the target layer; determining a second feature corresponding to the target layer and a corresponding weight based on the save information; and performing the image generation based on the first feature, the second feature, the weight, and the subject information.

For ease of description, when described, the above apparatus is divided into various modules based on functions. Certainly, functions of the modules may be implemented in one or more pieces of software and/or hardware when the embodiments of the present disclosure are implemented.

The apparatus in the above embodiment is configured to implement the corresponding method 500 in the above embodiments, and has the beneficial effects of the embodiments of the corresponding method 500, which are not repeated herein.

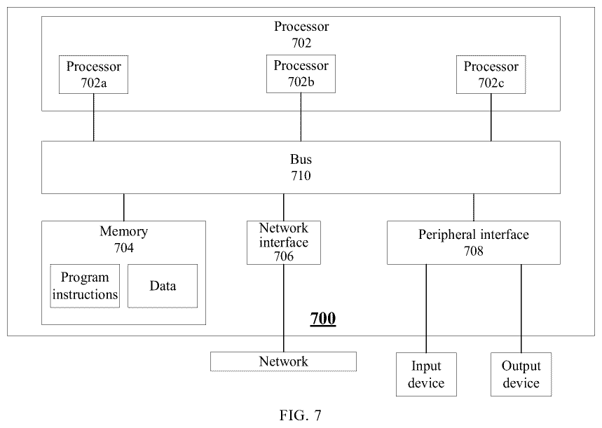

Based on the same technical concept, corresponding to the method in any one of the above embodiments, an embodiment of the present disclosure further provides a computer device, to implement the above method 500. FIG. 7 is a schematic diagram of a hardware structure of an exemplary computer device 700 according to an embodiment of the present disclosure. The computer device 700 may be configured to implement the terminal device 102 in FIG. 1. In some scenarios, the computer device 700 may alternatively be configured to implement the server 104 or the database server 106 in FIG. 1.

As shown in FIG. 7, the computer device 700 may include a processor 702, a memory 704, a network module 706, a peripheral interface 708, and a bus 710. The processor 702, the memory 704, the network module 706, and the peripheral interface 708 are communicatively connected to each other within the computer device 700 through the bus 710.

The processor 702 may be a central processing unit (CPU), an image processor, a neural processing unit (NPU), a microcontroller unit (MCU), a programmable logic device, a digital signal processor (DSP), an application-specific integrated circuit (ASIC), or one or more integrated circuits. The processor 702 may be configured to perform functions related to the technology described in the present disclosure. In some embodiments, the processor 702 may alternatively include a plurality of processors integrated into a single logical component. For example, as shown in FIG. 7, the processor 702 may include a plurality of processors 702a, 702b, and 702c.

The memory 704 may be configured to store data (e.g., instructions and computer code). As shown in FIG. 6, the data stored in the memory 704 may include program instructions (e.g., program instructions for implementing the method 500 in the embodiments of the present disclosure) and data to be processed (e.g., the memory may store configuration files for other modules). The processor 702 may also access the program instructions and the data stored in the memory 704 and execute the program instructions to operate the data to be processed. The memory 704 may include a volatile storage apparatus or a non-volatile storage apparatus. In some embodiments, the memory 704 may include a random access memory (RAM), a read-only memory (ROM), an optical disk, a magnetic disk, a hard drive, a solid state drive (SSD), a flash memory, a memory stick, etc.

The network interface 706 may be configured to provide communication between the computer device 700 and other external devices via a network. The network may be any wired or wireless network capable of transmitting and receiving data. For example, the network may be a wired network, a local wireless network (e.g., Bluetooth, Wi-Fi, and near field communication (NFC)), a cellular network, the Internet, or a combination of the above. It should be understood that the type of network is not limited to the above specific examples.

The peripheral interface 708 may be configured to connect the computer device 700 with one or more peripheral apparatuses to achieve information input and output. For example, the peripheral apparatus may include an input device such as a keyboard, a mouse, a touchpad, a touchscreen, a microphone, and various sensors, and an output device such as a display, a speaker, a vibrator, and an indicator light.

The bus 710 may be configured to transmit information between various components of the computer device 700 (e.g., the processor 702, the memory 704, the network interface 706, and the peripheral interface 708), such as an internal bus (e.g., a processor-memory bus) and an external bus (a USB port and a PCI-E bus).

It should be noted that although only the processor 702, the memory 704, the network interface 706, the peripheral interface 708, and the bus 710 are shown in the architecture of the above computer device 700, during a specific implementation, the architecture of the computer device 700 may further include other components necessary for normal operation. In addition, those skilled in the art should understand that the architecture of the above computer device 700 may include only components necessary for implementing the solutions of the embodiments of the present disclosure, and does not necessarily include all the components shown in the figures.

Based on the same technical concept, corresponding to the method in any one of the above embodiments, the present disclosure further provides a non-transitory computer-readable storage medium storing computer instructions, where the computer instructions are used to cause the computer to perform the method 500 in any one of the above embodiments.

The computer-readable medium in this embodiment includes permanent and non-permanent, removable and non-removable media and may implement information storage by using any method or technology. Information may be computer-readable instructions, data structures, modules of a program, or other data. Examples of the computer storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, magnetic tape disk storage or other magnetic storage devices, or any other non-transmission media that may be used to store information accessible by a computing device.

The computer instructions stored on the storage medium in the above embodiment are used to cause the computer to perform the method 500 in any one of the above embodiments, and have the beneficial effects of the corresponding method embodiment, which are not repeated herein.

Based on the same technical concept, corresponding to the method 500 in any one of the above embodiments, the present disclosure further provides a computer program product including computer program instructions which, when run on a computer, cause the computer to perform the method 500 in any one of the above embodiments. In some embodiments, the computer program instructions may be executed by one or more processors of the computer to cause the computer and/or the processors to perform the method 500. Corresponding to execution bodies corresponding to the various steps in the various embodiments of the method 500, the processor that performs the corresponding step may belong to the corresponding execution body.

The computer program product in the above embodiment is used to cause the computer and/or the processors to perform the method 500 in any one of the above embodiments, and has the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples; and with the concept of the present disclosure, the technical features in the above embodiments or different embodiments may also be combined, steps may be implemented in any order, and many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the accompanying drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the above description. For example, the discussed embodiments may be used for other memory architectures (e.g., a dynamic RAM (DRAM)).

The embodiments of the present disclosure are intended to cover all such substitutions, modifications, and variations that fall within the broad scope of the appended claims. Therefore, any omissions, modifications, equivalent substitutions, improvements etc., made within the spirit and principle of the embodiments of the present disclosure are intended to be included within the scope of protection of the present disclosure.

I/We claim:

1. An image generation method, comprising:
displaying at least two first options on an operation interface in response to an image editing operation, and determining a first selected option based on a first operation on the at least two first options;
determining a target layer corresponding to the first selected option, displaying at least two second options corresponding to the target layer on the operation interface, determining a second selected option based on a second operation on the at least two second options, and adjusting a display state of the second selected option on the operation interface;
displaying a first adjustment region for the second selected option on the operation interface in response to a third operation on the second selected option, and generating save information based on a fourth operation on the first adjustment region; and
performing image generation based on the save information in response to an image generation operation.

2. The method according to claim 1, wherein the at least two first options comprise a first sub-option configured to correspond to a blended layer, wherein when the first sub-option is the first selected option, the blended layer is the target layer; and
the displaying at least two second options corresponding to the target layer on the operation interface comprises:
expanding a first region corresponding to the first sub-option on the operation interface; and
displaying the at least two second options corresponding to the first sub-option in the first region.

3. The method according to claim 2, wherein determining the second selected option based on the second operation on the at least two second options, and adjusting the display state of the second selected option on the operation interface comprises:
determining, based on the second operation on any of the second options, the operated second option as the second selected option; and
setting a first identifier for the second selected option to adjust the display state of the second selected option.

4. The method according to claim 2, wherein adjusting the display state of the second selected option on the operation interface comprises:
deselecting, in response to the number of second selected options present on the operation interface exceeding a set threshold, the second selected option that is determined the earliest in time, and generating first prompt information.

5. The method according to claim 1, wherein the at least two first options comprise a second sub-option configured to correspond to at least one base layer, wherein when the second sub-option is the first selected option, determining the target layer corresponding to the first selected option comprises:
expanding a second region corresponding to the second sub-option on the operation interface; and
displaying at least one icon corresponding to the at least one base layer on the second region, and determining, based on a fifth operation on any of the at least one icon, the base layer corresponding to the operated icon as the target layer.

6. The method according to claim 5, wherein the fifth operation on any of the at least one icon comprises:
displaying at least one second identifier corresponding to the at least one base layer in the second region; and
determining a selection operation on any of the at least one second identifier as the fifth operation on the icon corresponding to the selected second identifier.

7. The method according to claim 6, wherein displaying at least two second options corresponding to the target layer on the operation interface, determining the second selected option based on the second operation on the at least two second options comprises:
generating a third region at one side of the selected second identifier, and displaying the at least two second options in the third region; and
determining, based on the second operation on any of the at least two second options, the operated second option as the second selected option, and setting a third identifier for the second selected option.

8. The method according to claim 7, wherein adjusting the display state of the second selected option on the operation interface comprises:
canceling the third region in response to a sixth operation on the selected second identifier or a region outside the third region; and
displaying the second selected option in a region of the second region that corresponds to the operated icon.

9. The method according to claim 5, wherein after displaying at least one icon corresponding to the at least one base layer in the second region, the method further comprises:
displaying, in response to the number of the at least one base layer exceeding a set threshold, a set threshold number of the at least one icon in the second region, and generating third prompt information.

10. The method according to claim 1, wherein performing image generation based on the save information in response to the image generation operation comprises:
determining a first feature and subject information of the target layer;
determining a second feature corresponding to the target layer and a corresponding weight based on the save information; and
performing the image generation based on the first feature, the second feature, the weight, and the subject information.

11. A computer device, comprising a memory, a processor, and a computer program stored on the memory and executable on the processor, wherein the computer program, when executed by the processor, causes the computer device to:
display at least two first options on an operation interface in response to an image editing operation, and determine a first selected option based on a first operation on the at least two first options;
determine a target layer corresponding to the first selected option, display at least two second options corresponding to the target layer on the operation interface, determine a second selected option based on a second operation on the at least two second options, and adjust a display state of the second selected option on the operation interface;
display a first adjustment region for the second selected option on the operation interface in response to a third operation on the second selected option, and generate save information based on a fourth operation on the first adjustment region; and
perform image generation based on the save information in response to an image generation operation.

12. The computer device according to claim 11, wherein the at least two first options comprise a first sub-option configured to correspond to a blended layer, wherein when the first sub-option is the first selected option, the blended layer is the target layer; and
the computer program causing the computer device to display at least two second options corresponding to the target layer on the operation interface further causes the computer device to:
expand a first region corresponding to the first sub-option on the operation interface; and
display the at least two second options corresponding to the first sub-option in the first region.

13. The computer device according to claim 12, wherein the computer program causing the computer device to determine the second selected option based on the second operation on the at least two second options, and adjust the display state of the second selected option on the operation interface further causes the computer device to:
determine, based on the second operation on any of the second options, the operated second option as the second selected option; and
set a first identifier for the second selected option to adjust the display state of the second selected option.

14. The computer device according to claim 12, wherein the computer program causing the computer device to adjust the display state of the second selected option on the operation interface further causes the computer device to:
deselect, in response to the number of second selected options present on the operation interface exceeding a set threshold, the second selected option that is determined the earliest in time, and generate first prompt information.

15. The computer device according to claim 11, wherein the at least two first options comprise a second sub-option configured to correspond to at least one base layer, wherein when the second sub-option is the first selected option, the computer program causing the computer device to determine the target layer corresponding to the first selected option further causes the computer device to:
expand a second region corresponding to the second sub-option on the operation interface; and
display at least one icon corresponding to the at least one base layer on the second region, and determine, based on a fifth operation on any of the at least one icon, the base layer corresponding to the operated icon as the target layer.

16. The computer device according to claim 15, wherein the fifth operation on any of the at least one icon further comprises:
displaying at least one second identifier corresponding to the at least one base layer in the second region; and
determining a selection operation on any of the at least one second identifier as the fifth operation on the icon corresponding to the selected second identifier.

17. The computer device according to claim 16, wherein the computer program causing the computer device to display at least two second options corresponding to the target layer on the operation interface, determine the second selected option based on the second operation on the at least two second options further causes the computer device to:
generate a third region at one side of the selected second identifier, and display the at least two second options in the third region; and
determine, based on the second operation on any of the at least two second options, the operated second option as the second selected option, and set a third identifier for the second selected option.

18. The computer device according to claim 17, wherein the computer program causing the computer device to adjust the display state of the second selected option on the operation interface further causes the computer device to:
cancel the third region in response to a sixth operation on the selected second identifier or a region outside the third region; and
display the second selected option in a region of the second region that corresponds to the operated icon.

19. The computer device according to claim 15, wherein after displaying at least one icon corresponding to the at least one base layer in the second region, the computer program further causes the computer device to:
display, in response to the number of the at least one base layer exceeding a set threshold, a set threshold number of the at least one icon in the second region, and generate third prompt information.

20. A non-transitory computer-readable storage medium storing computer instructions, wherein the computer instructions are configured to cause a computer to:
display at least two first options on an operation interface in response to an image editing operation, and determine a first selected option based on a first operation on the at least two first options;
determine a target layer corresponding to the first selected option, display at least two second options corresponding to the target layer on the operation interface, determine a second selected option based on a second operation on the at least two second options, and adjust a display state of the second selected option on the operation interface;
display a first adjustment region for the second selected option on the operation interface in response to a third operation on the second selected option, and generate save information based on a fourth operation on the first adjustment region; and
perform image generation based on the save information in response to an image generation operation.
